(19) United States
(12) Patent Application Publication
(10) Pub. No.: US 2009/0199574 A1
(43) Pub. Date: Aug. 13, 2009

(54) Hydrogen storage device

(76) Inventors: Katsuhiko Hirose, Aichi (JP); Daigoro Mori, Shizuoka (JP)

Correspondence Address: KENYON & KENYON LLP, 1500 K STREET N.W., SUITE 700, WASHINGTON, DC, 20005, US

(21) Appl. No.: 11/991,265

(22) PCT Filed: Sep. 1, 2006
(86) PCT No.: PCT/JP2006/317347

§ 371 Date: Mar. 27, 2008

(30) Foreign Application Priority Data
Sep. 2, 2005 (JP) 2005-255446

(51) Int. Cl. F17C 11/00; F17C 9/00; F17C 13/00

(52) U.S. Cl. 62/46.1; 220/560.04; 62/50.1; 62/50.7; 62/51.1

(57) ABSTRACT

When hydrogen is taken out, para-hydrogen having a low energy is converted into ortho-hydrogen having a high energy, and a cooling effect of endothermy of the para-ortho conversion is utilized for maintaining the temperature within a hydrogen storage device low. For accomplishing such a system, there is provided a hydrogen storage device for storing a liquid hydrogen, wherein a porous magnetic body serving as a para-ortho conversion catalyst is arranged in a hydrogen circulation.

### TECHNICAL FIELD

The present invention relates to a hydrogen storage device, and in particular to a hydrogen storage device suitable for absorbing and storing hydrogen

### BACKGROUND ART

Fuel cells, engines and the like that use hydrogen as fuel have recently been put into practice, and there has been widespread research into methods and devices for absorbing and storing hydrogen for supply to such fuel cells and engines.

Known conventional hydrogen storing methods include, for example, a hydrogen storing method of pressurizing and storing hydrogen in a high pressure hydrogen gas canister, and a hydrogen storing method of cooling and storing liquefied hydrogen in a low temperature container.

When storing as liquid hydrogen, storage is made with a low temperature container and latent heat. Therefore, heat penetrates from outside with the passage of time, and there is gradual vaporization of the liquid hydrogen meaning that appropriate long-term storage is not possible, and so there is low practicality for use as fuel applications. In addition, hydrogen gas must be quickly released after it has been vaporized, and so the use of liquid hydrogen as a fuel is also difficult from the standpoint of efficiency.

Another known hydrogen storage technology, other than the above, is to use carbon materials such as activated carbon and carbon nanotubes for hydrogen storage. There is, for example, a disclosure related to a hydrogen gas storage method in which hydrogen gas is absorbed to activated carbon, by magnetic bodies such as iron oxide being held on, or contacted with, activated carbon particles (see, for example, Japanese Patent Application Laid-Open (JP-A) No. 2001-12693). Disclosed in such a method is the use of liquefaction, with magnetic bodies used as a catalyst and held on activated carbon, in order to promote conversion from ortho-hydrogen into para-hydrogen which is stable at low temperatures.

Hydrogen generally exists as para-hydrogen and ortho-hydrogen forms, distinguished by the differences between the spin angular momentum thereof, and at room temperature ortho-hydrogen and para-hydrogen exist at a ratio of 3:1. At low temperatures, however, all of the hydrogen becomes para-hydrogen since the energy of para-hydrogen is lower than ortho-hydrogen. The conversion rate is slow, but ortho-para conversion is possible by cooling, and, while the conversion rate is slow at low temperature, para-ortho conversion is also possible.

### DISCLOSURE OF INVENTION

Problem to be Solved by the Invention

In reality, however, in hydrogen storage devices configured using carbon-based materials, when magnetic bodies are incorporated within a device (tank), since the capacity for the carbon-based material is reduced relatively, there is a limit to the amount by which the hydrogen absorption amount can be raised. Furthermore, in configuration with magnetic bodies disposed at the inlet to the tank, and a filter provided to suppress the carbon-based material from flying about, the filter and the magnetic bodies impede the inflow/outflow of gas and cause a pressure loss.

Furthermore, when ortho-para conversion occurs, conversion energy is generated, and hydrogen that is in a liquid state re-vaporizes due to this conversion energy, making it difficult in practice to hold hydrogen for long periods in a tank formed with thin walls using, for example, carbon fibers of the like.

The present invention is made in consideration of the above, and an object of the present invention is to provide a hydrogen storage device that is capable of storing a large amount of hydrogen for a long period of time, without an accompanying increase in pressure loss occurring at the hydrogen flow opening of the tank.

Method of Solving the Problem

The present invention has been made on the basis of the discovery that, when configuration is made such that para-hydrogen is converted into ortho-hydrogen when hydrogen is handled, the cooling effect of absorbed heat during para-ortho conversion may be used for maintaining the internal storage tank at low temperature. The specific method by which the above problem is solved is set out below.

In order to achieve the above object, a hydrogen storage device of a first aspect of the present invention is configured with a tank provided with a hydrogen flow opening, and a hydrogen absorbing material in at least one portion of the tank; and a porous magnetic body disposed at the hydrogen flow opening.

In the hydrogen storage device of the present invention, the fill amount of hydrogen absorbing material in the tank may be secured, by providing the hydrogen absorbing material within the tank and providing the porous magnetic body not disposed within the tank, but instead disposing the porous magnetic body at the hydrogen flow opening of the tank. A large amount of hydrogen may thereby be stored. Furthermore, when supplying or venting the hydrogen, and in particular when venting the hydrogen, since the hydrogen that has been stored is para-ortho converted and then vented, a cooling effect is obtained due to the heat absorbed with the para-ortho conversion, and the tank and the tank internal atmosphere may be maintained at a low temperature.

By also providing the porous magnetic body at the hydrogen flow opening, since there is also a filtering ability within the porous magnetic body, it is not necessary to provide both the porous magnetic body and a filter at the hydrogen flow opening, and an increase in the pressure loss at the hydrogen flow opening may be suppressed.

The hydrogen absorbing material is filled to at least one portion of the tank interior, and the hydrogen absorbing material physically attracts and holds the hydrogen (in particular liquid hydrogen) that has been supplied from the outside of the hydrogen absorbing material in the form of hydrogen molecules. Liquid hydrogen may be supplied and stored within the tank. of the hydrogen storage device. Within the tank, hydrogen is maintained in the liquid state, and when the hydrogen vaporizes and becomes in the gaseous state, the hydrogen is attracted and held by the hydrogen absorbing material that is disposed either in a contact or non-contact state to the liquid hydrogen. Configuration is such that the hydrogen that has been held by the hydrogen absorbing material may be taken out from the hydrogen flow opening as required.

The hydrogen absorbing material of the present invention is of a substance that is able to attract and hold hydrogen molecules to the surface thereof, and is distinct from hydrogen absorbing alloys which capture and store hydrogen as hydrogen atoms.

The tank configuring the hydrogen storage device of the present invention may be appropriately configured using a thermal insulating container. Heat transmission from outside to inside the tank may be suppressed by configuring the tank as a thermal insulating container, and vaporization of liquid hydrogen may be suppressed when liquid hydrogen has been stored within the hydrogen storage device, this being effective for securing a long period of hydrogen storage.

The hydrogen flow opening may be configured with a hydrogen flow inlet for filling gaseous or liquid hydrogen into the tank, and with a hydrogen flow outlet for taking out hydrogen that has been stored from within the tank to outside of the tank. In such a case, a configuration in which the porous magnetic body is disposed at the hydrogen flow outlet is effective.

When, for example, filling and storing liquid hydrogen in the tank, the interior of the tank is maintained at a low temperature, and the hydrogen is stored at low temperature as para-hydrogen. When the stored para-hydrogen is taken out from the hydrogen flow outlet, an endothermic reaction may be initiated by ortho-para conversion under the action of the porous magnetic body that has been disposed at the hydrogen flow outlet, and a low temperature may be maintained of the tank and the atmosphere within the tank (tank internal atmosphere) by the latent heat of conversion. That is, vaporization of the liquid hydrogen may be suppressed, which provides a beneficial effect for securing a long period of hydrogen storage.

The cooling effect due to the latent heat mentioned above, together with the reduction in tank internal pressure that accompanies taking hydrogen out from the tank, provide beneficial effects for securing a long period of hydrogen storage.

Disposing the porous magnetic body so as to be able to exchange heat with a structural member of the tank is effective. It is particularly effective for the tank to be configured by using a metal material, in a configuration where heat exchange with the metal material is possible.

The porous magnetic body itself is cooled by the latent heat when hydrogen is taken out from within the tank, as described above. By disposing the porous magnetic body to enable heat exchange with structural member of the tank, the tank itself may be cooled, and the internal atmosphere of the tank may be maintained at a low temperature. That is, there is a beneficial effect for securing a long period of hydrogen storage by suppressing the vaporization of the liquid hydrogen when the hydrogen is used.

There is a beneficial effect from using a the tank includes a thermal insulating structure containing a shield material that includes a metal layer, the shield material being disposed between a thermal insulating material, and the porous magnetic body is disposed so as to be able to exchange heat with the shield material. The transmission of heat into the tank may be greatly suppressed by configuring the tank with a thermal insulating structure of containing the shield material, that shadows heat, is sandwiched between a thermal insulating material, and also the tank itself may be more effectively cooled by heat exchange with the porous magnetic body that is cooled when hydrogen is taken out. The tank internal atmosphere may also be maintained at a low temperature. That is, in addition to increasing the absorption amount, vaporization of liquid hydrogen is suppressed, and a longer period of hydrogen storage may be secured.

The porous magnetic body may also be disposed in a position that is in contact with the internal atmosphere of the tank, and direct cooling of the tank internal atmosphere may be carried out. The porous magnetic body is preferably disposed so as to be able to exchange heat with the tank structural member of the tank, as in the above manner, and also in a position so as to also be able to exchange heat with the internal atmosphere of the tank. The tank may thereby not only be cooled, but also the cooling effect may be enhanced by a configuration in which the tank internal atmosphere, which is the region in which the hydrogen is stored, may be cooled at the same time. Therefore, by increasing the absorption amount further, and also by being able to maintain a low temperature of the tank internal atmosphere more stably, vaporization of the liquid hydrogen may be avoided, and a longer period of hydrogen storage may be secured.

Examples of the hydrogen absorbing material include activated carbon, carbon nanotubes and MOF. Examples of the porous magnetic body include iron oxide, a mixed of silica gel and nickel, and alumina on a chromium oxide carrier.

A hydrogen flow tube that hydrogen flows through is connected to the hydrogen flow outlet, and the porous magnetic body may be held at at least one portion of the internal wall of the hydrogen flow tube and be filled at least one portion of the hydrogen flow tube. The hydrogen flow tube may be disposed along one portion of the external wall of the tank.

The hydrogen absorbing material may be provided within the tank at a face of an upper wall disposed in the opposite direction to the direction in which gravity acts. The shield material may be a polyester film which has been subjected to aluminum vapor deposition carried out on only one side.

Furthermore, the thermal insulating structure may include a layered structure including thermal insulating material, aluminum plate and thermal insulating material.

A hydrogen storage device of a second aspect of the present invention is configured with a porous magnetic body disposed at a hydrogen flow opening of a tank.

In the present aspect also, in the same way as described above, liquid hydrogen may be supplied and stored in the tank of the hydrogen storage device. An effective configuration is with the tank configured to include a thermal insulating structure containing a shield material that includes a metal layer, the shield material being disposed between a thermal insulating material, with the porous magnetic body disposed so as to be able to exchange heat with the shield material. Examples the porous magnetic body include iron oxide, a mixture of silica gel and nickel, and alumina on a chromium oxide carrier. A hydrogen flow tube that hydrogen flows through may be connected to the hydrogen flow outlet, and the porous magnetic body may be held at, or be filled in, at least one portion of the hydrogen flow tube, and the hydrogen flow tube may be disposed along a face of the external wall of the tank.

### EFFECT OF THE INVENTION

According to the present invention, a hydrogen storage device is provided that may store a large amount of hydrogen for a long storage period, without an accompanying increase in the pressure loss at the hydrogen flow opening of a tank.

### BRIEF DESCRIPTION OF THE DRAWINGS

FIG. 1 is a perspective view showing a hydrogen storage device according to a first exemplary embodiment of the invention.

FIG. 2 is a cross-section of the hydrogen storage device of FIG. 1, taken on line A-A′.

FIG. 3A is a schematic diagram showing a manner in which a para-ortho conversion catalyst is held at the inner wall face of a hydrogen vent tube of a hydrogen storage device according to the first exemplary embodiment of the present invention.

FIG. 3B is a schematic diagram showing a manner in which a para-ortho conversion catalyst is filled into a hydrogen vent tube of a hydrogen storage device according to the first exemplary embodiment of the present invention.

FIG. 4 is a cross-section showing a hydrogen storage device according to a second exemplary embodiment of the present invention.

### BEST MODE FOR CARRYING OUT THE INVENTION

A detailed explanation of exemplary embodiments of a hydrogen storage device according to the present invention will be given below, with reference to the drawings.

### FIRST EXEMPLARY EMBODIMENT

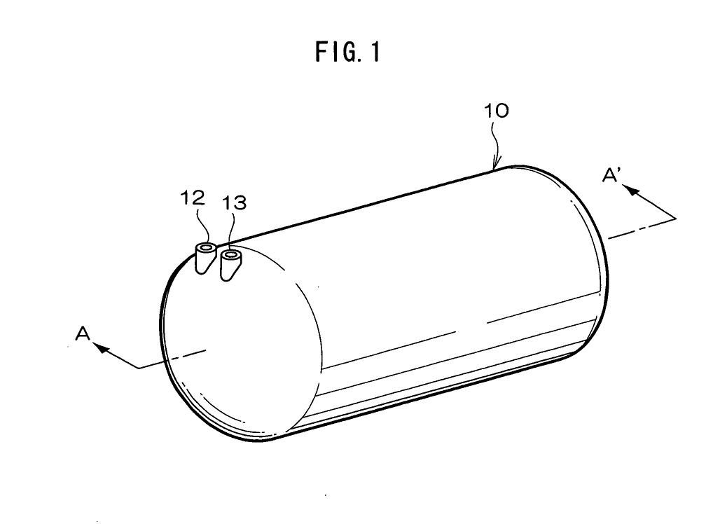

A first exemplary embodiment of the present invention will be explained, with reference to FIGS. 1 to 3B. The hydrogen storage device of the present exemplary embodiment is configured to enable the tank internal temperature to be held low and for hydrogen to be stored for a long period, the hydrogen storage device including a tank (container) provided with activated carbon (hydrogen absorbing material) at a face of an upper internal wall, and with a porous magnetic body having iron oxide as a principal constituent disposed at a hydrogen flow outlet provided to the tank (container) and inside a hydrogen vent tube that is communicated with the hydrogen flow outlet.

A hydrogen storage device 10 of the present exemplary embodiment is configured, as shown in FIG. 1, with a circular cross-section cylindrical container that has both end faces closed off with substantially half-sphere-shaped curved faces. The wall face thereof is provided with a hydrogen flow inlet 12 and a hydrogen flow outlet 13 that holds a porous magnetic body having iron oxide as a principal constituent. The porous magnetic body is also held in a hydrogen vent tube 16. Specific explanation thereof is given below.

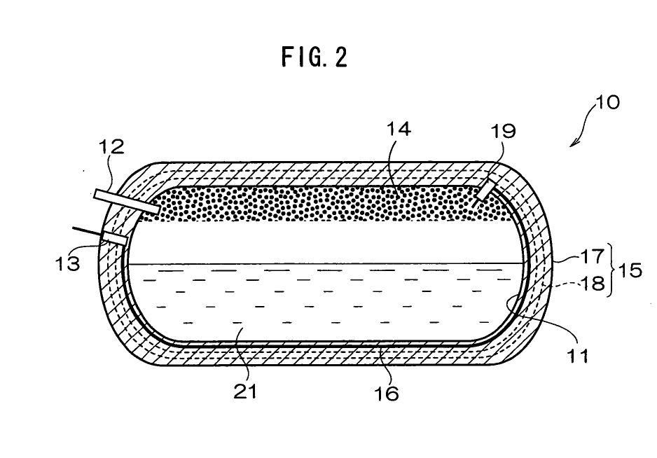

The present exemplary embodiment, as shown in FIG. 2, is provided with: a stainless steel container 11, made from a stainless alloy (SUS316L), with a hollow and circular cross-section cylindrical body that has both end faces closed off with substantially half-sphere-shaped curved faces, the stainless steel container 11 being provided with a hydrogen flow inlet and hydrogen flow outlet; activated carbon (hydrogen absorbing material) 14 disposed in the stainless steel container 11; a thermal insulating layer 15 disposed so as to cover the entire face of the external wall of the stainless steel container 11; and a hydrogen vent tube 16 that is buried within the thermal insulating layer 15 so as to communicate the hydrogen flow outlet 13 and the activated carbon 14, the hydrogen vent tube 16 holding a porous magnetic body, which has iron oxide as a principal constituent, on the internal wall of the tube.

The stainless steel container 11 is a hollow container that has been formed into a cylindrical shape from a stainless steel alloy (SUS316L) with both ends in the length direction of the cylinder being closed off with substantially half-sphere-shaped curved faces, such that the stainless steel container 11 has an intensity of withstand pressure of about 0.5 to 3.0 MPa and an internal volume of about 70 to 200 L (liters).

The cross-sectional shape and the size of the stainless steel container may be chosen shape other than circular, such as a rectangular or elliptical cross-section, and the size, in accordance with the intended use. The stainless steel container may also be configured from a material other than stainless steel alloy, such as an aluminum alloy, CFRP, or GFRP.

The hydrogen flow inlet 12 and the hydrogen flow outlet 13 are provided as hydrogen flow openings in a wall face of the stainless steel container 11. Configuration is such that liquid hydrogen may be supplied from outside through the hydrogen flow inlet 12 and into the stainless steel container, and hydrogen that is stored within the stainless steel container may be taken out, as required, through the hydrogen flow outlet 13.

Within the hollow of the stainless steel container 11, there is a metal mesh provided to the upper wall face thereof that is in the opposite direction to that in which gravity acts, and the activated carbon (hydrogen absorbing material) 14 is disposed in a plate shape, as shown in FIG. 2. The configuration is such that, as shown in FIG. 2, liquid hydrogen 21 that has been supplied from the hydrogen flow inlet 12 may be stored in the space other than in the region in which the activated carbon 14 is disposed. Hydrogen that vaporizes when the liquid hydrogen 21 is supplied, or hydrogen which has become a gas by vaporization from the stored liquid hydrogen, is absorbed and held as hydrogen molecules in the activated carbon 14. With regard to this absorption, the hydrogen is not adsorbed and stored in the atomic state, but rather is physically attracted in the state of hydrogen molecules.

Adding the activated carbon, the hydrogen absorbing material preferably includes carbon nanotubes, and MOFs (metal-organic frameworks) such as Zn₄O (1,4-benzenedicarboxylate dimethyl)₃ and the like. These may be used in any of forms such as granules, pellets, or powders, or any of forms packed into pockets and meshes, nets or the like, as long as contact with the atmosphere is not impeded.

The thermal insulating layer 15 is disposed so as to cover the entire face of the external wall at the outside of the stainless steel container 11. The thermal insulating layer 15 is configured from a thermal insulating material 17 and a cooling shield 18 made from an aluminum plate having a thickness of 1 mm or less, and configured to be a layered structure of multiple layers with the cooling shield being sandwiched between thermal insulating materials. In the present invention, three layers of thermal insulating material is laminated in a multi-layer structure of thermal insulating layer/aluminum plate/thermal insulating layer/aluminum plate/thermal insulating layer.

The thermal insulating material 17 is a laminated vacuum thermal insulating material (multi-layer insulation; MLI) formed with alternate layers of: a thin film of radiation shield material, which is a polyester film which has aluminum vapor deposited on both sides thereof; and spacer material(s), for holding the thin films of radiation shield material in a non-contact state to each other so as to avoid thermal transmission therebetween. This laminated vacuum thermal insulating material insulates from external heat and maintains the stainless steel container and contents thereof at a low temperature for a long period of time, avoiding the rapid vaporization of the liquid hydrogen 21 stored therein, and enabling hydrogen to be stored for a long period of time.

The radiation shield material may be a polyester film with aluminum vacuum deposited only on one side thereof, or may be configured from a resin film other than a polyester film. Glass fiber cloth or paper, nylon net, or the like may be preferably used as the spacer material. In the MLI, if there are N sheets of the shield material inserted therein, the amount of heat penetration due to radiation may be reduced to 1/(N+1).

The configuration of the thermal insulating layers may be suitably selected according to the purpose and application. Other than three layers of the thermal insulating material, the number of layers may be a single layer, a double layer or four or more layers. The cooling shield material may be configured from a material other than aluminum which enables a thermal insulating effect to be obtained.

The hydrogen vent tube 16 is buried within the thermal insulating material 17 that is closest to the stainless steel container 11 and disposed along a face of the external wall of the stainless steel container 11, at the inside of the thermal insulating layer 15 that covers the stainless steel container 11. The hydrogen vent tube 16 passes through inside the tube and vent hydrogen, and also the thermal insulating layer 15 insulates the hydrogen vent tube 16 from external heat (for example 290 to 310 K), while at the same time the stainless steel container is cooled by heat exchange with the hydrogen vent tube 16.

One end of the hydrogen vent tube 16 is connected to a hydrogen flow outlet 19 disposed in the activated carbon 14 to enable hydrogen that is absorbed and held in the activated carbon 14 to be taken out. The other end of the hydrogen vent tube 16 is connected to the hydrogen flow outlet 13. Configuration is made such that by hydrogen passing through the hydrogen vent tube 16, venting or supplying to the outside of hydrogen stored within the stainless steel container 11 may be carried out. When required, the hydrogen that is absorbed in the activated carbon (hydrogen absorbing material) 14 may be vented from the hydrogen flow outlet 13 by passing through the hydrogen vent tube 16 from the hydrogen flow outlet 19, and hydrogen may be supplied to a hydrogen using device is connected with the hydrogen flow outlet 13.

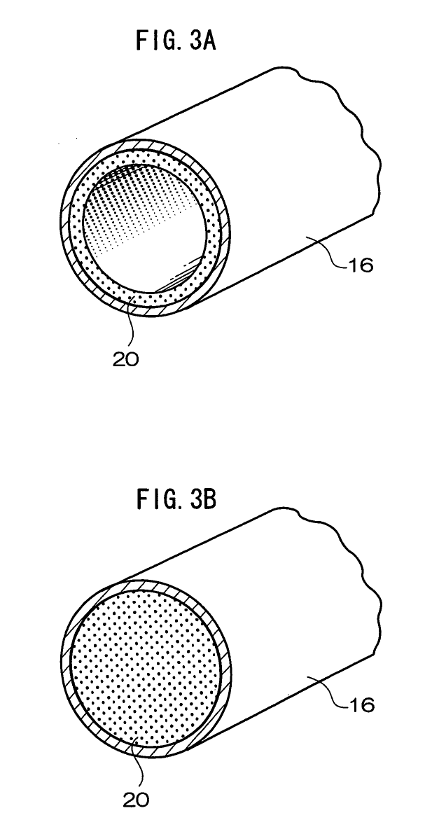

In the hydrogen vent tube 16, as shown in FIG. 3A, there is a porous magnetic body 20 having iron oxide as a principal component held uniformly on the entire surface of the internal wall of the hydrogen vent tube 16 from the end that is connected to the hydrogen flow outlet 19 toward the other end that faces the hydrogen flow outlet 13, so that the relative surface area is as large as possible. The porous magnetic body 20 lets hydrogen that has been taken in from the hydrogen flow outlet 19 pass through while carrying out ortho-para conversion from para-hydrogen to ortho-hydrogen.

The porous magnetic body 20 having iron oxide as a principal component is filled into the inside of the tube near the hydrogen flow outlet 13, 19 of the hydrogen vent tube 16, as shown in FIG. 3B, so that the relative surface area is as large as possible. The function of filtering the hydrogen passing through for venting is thereby also imparted to the porous magnetic body 20. In the same way, the porous magnetic body having iron oxide as a principal component is also held and disposed in porous condition in regions of the hydrogen flow outlet 13, 19 that make contact with the hydrogen. The functions of carrying out para-ortho conversion and of filtering hydrogen passing through for venting are thereby imparted.

The porous magnetic body is an ortho-para conversion catalyst to carry out ortho-para conversion of hydrogen, and in addition to above porous magnetic body having iron oxide as a principal component, examples of porous magnetic body preferably include a mixture of silica gel and nickel, alumina held on a chromium oxide, or activated carbon to which oxygen has been absorbed, or the like.

At the temperature at which liquid hydrogen vaporizes or above, para-hydrogen changes into ortho-hydrogen under the action of a para-ortho conversion catalyst. This conversion from para-hydrogen to ortho-hydrogen (para-ortho conversion) proceeds in an endothermic manner. Therefore, when passing through inside the tube, the para-ortho conversion catalyst itself is cooled at the same time, and the hydrogen vent tube is also cooled, and thereby the stainless steel container 11 is maintained at a low temperature by heat exchange being carried out with the hydrogen vent tube.

That is, in para-ortho conversion of hydrogen, the para-hydrogen state is more stable in low temperature regions (for example at 20 K) and so para-ortho conversion is slow. Therefore, at the side near the one end of the hydrogen vent tube 16 (the hydrogen flow outlet 19 side), since hydrogen having low temperature flows in and a low temperature state is maintained, the conversion speed is slow, an no great heat absorbing effect may be obtained by para-ortho conversion. However, cooling may be obtained from the hydrogen having low temperature flowing in at the other end (at, for example, up to about 100K), and heat exchange with the stainless steel container may be obtained. The stainless steel container and atmosphere within the container may thereby be maintained at a low temperature. Then, the hydrogen that is within the hydrogen vent tube further gradually rises in temperature as it passes through the tube toward the hydrogen flow outlet 13 side, and at the other end of the tube that is connected to the hydrogen flow outlet 13 para-ortho conversion readily occurs. When para-hydrogen is gradually converted to ortho-hydrogen, the downstream side of the hydrogen vent tube near the hydrogen flow outlet 13 is cooled to a low temperature by the endothermic with conversion. When this happens, since para-ortho conversion also occurs at the hydrogen flow outlet 13, the radiation shield material (aluminum) of the thermal insulating material 17 and the cooling shield (aluminum plate) 18, which are in contact with the hydrogen flow outlet 13, are cooled by heat exchange therewith.

That is, when hydrogen is vented, the hydrogen vent tube 16 is cooled by the latent heat during para-ortho conversion at the downstream side near the hydrogen flow outlet 13. Furthermore, the stainless steel container itself, and also the atmosphere within the stainless steel container, may be maintained at a low temperature by heat exchange with the stainless steel container and also by heat exchange with the radiation shield material and the cooling shield (aluminum sheet) 18.

After hydrogen has been sufficiently absorbed to the activated carbon 14, the activated carbon 14 may make contact with the stored liquid hydrogen 21. Even if liquid hydrogen contacts the hydrogen absorbing material that has sufficiently absorbed hydrogen, the liquid hydrogen does not boil since there is no absorption heat generated.

In the present exemplary embodiment, the para-ortho conversion catalyst (porous magnetic body) is held on the entire internal wall of the hydrogen vent tube 16. However, there is no necessity for it to be held on the entire internal wall of the tube, and it may be held only on a portion thereof. In such a case, since the para-ortho conversion speed is slower in the low temperature region, as stated above, it is effective to hold the para-ortho conversion catalyst at the downstream side in the hydrogen flow direction. In particular, it is preferable to hold the para-ortho conversion catalyst adjacent to the other end of the hydrogen vent tube 16, that is, locally in the downstream side region near the hydrogen flow outlet 13, since by doing so an endothermic effect (cooling) may effectively be obtained with a small amount of held catalyst.

According to requirements, the para-ortho conversion catalyst (porous magnetic body) may be disposed not only at the hydrogen flow outlet, but instead only at the hydrogen flow inlet, or at both the hydrogen flow outlet and the hydrogen flow inlet. A heater may be further disposed within the stainless steel container 11, so as to be able to more readily take out hydrogen.

### SECOND EXEMPLARY EMBODIMENT

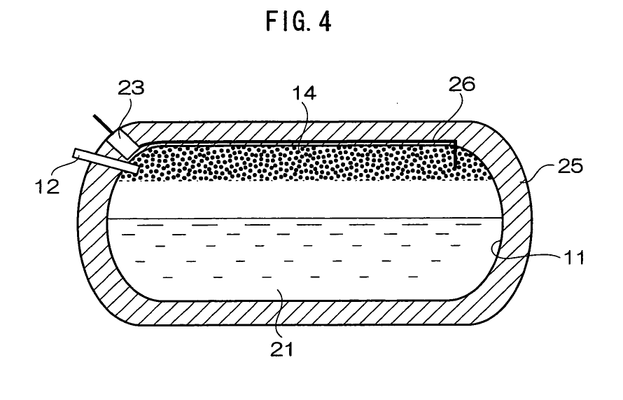

A second exemplary embodiment of the present invention will be explained, with reference to FIG. 4. The present exemplary embodiment is configured to enable the stainless steel container to be cooled by holding a para-ortho conversion catalyst (porous magnetic body) at the hydrogen flow outlet and exchanging heat with the vapor deposited aluminum of the MLI.

It should be noted that liquid hydrogen may be used for the hydrogen, in the same manner as in the first exemplary embodiment, and similar components to those of the first exemplary embodiment are allocated the same reference numerals and detailed explanation thereof is omitted.

In the present exemplary embodiment, there is a hydrogen flow outlet 23 formed from stainless steel alloy (SUS316L) installed within a thermal insulating layer 25. One end of a hydrogen vent tube 26 is connected to the hydrogen flow outlet 23, the other end of the hydrogen vent tube 26 being connected to the activated carbon (hydrogen absorbing material) 14, and hydrogen that has been taken out through the hydrogen vent tube 26 may be supplied to the outside.

In the hydrogen flow outlet 23, a porous magnetic body having iron oxide as a principal component is held in porous condition in regions which may be contacted with hydrogen that passes through. The configuration is such that when hydrogen is vented from the hydrogen flow outlet, at the same time as functioning as a filter, para-ortho conversion may be carried out from para-hydrogen to ortho-hydrogen.

The thermal insulating layer 25 is configured using multi-layer insulation (MLI) formed with alternate layers of: a thin film of radiation shield material, which is a polyester film which has aluminum vapor deposited on both sides thereof, and spacer material(s), for holding the thin films of radiation shield material in a non-contact state to each other so as to avoid thermal transmission therebetween. This multi-layer insulation insulates from external heat and maintains the stainless steel container 11 and the interior thereof at a low temperature for a long period of time, avoiding the rapid vaporization of the liquid hydrogen 21 stored therein, and enabling hydrogen to be stored for a long period of time.

The hydrogen flow outlet 23 is disposed so as to be able to contact with and exchange heat with the vapor deposited aluminum configuring the radiation shield material of the thermal insulating layer 25. When hydrogen is vented, para-ortho conversion and cooling occurs, and there is heat exchange with the vapor deposited aluminum at this time. The heat of the stainless steel container is emitted through the vapor deposited aluminum disposed so as to be wrapped around the container, and the stainless steel container 11 itself and the atmosphere within the container are maintained at a low temperature.

In the hydrogen vent tube 26, the para-ortho conversion catalyst may be disposed to a portion of the internal wall of the tube (preferably, at the downstream side of the tube) or over the entire face thereof, in the same manner as in the first exemplary embodiment.

Explanation has been given in the present exemplary embodiment focusing on a case in which heat exchange and cooling is only between with the vapor deposited aluminum configuring the radiation shield material of the MLI. However, in addition to heat exchange with the vapor deposited aluminum, the hydrogen flow outlet 23 may be connected and disposed so that heat exchange is possible with the stainless steel container 11 and/or with the atmosphere within the container. In such a case, cooling of the stainless steel container and/or the atmosphere itself is possible at the same time, and the cooling efficiency may be increased.

Explanation in the above exemplary embodiments has focused on cases when a hydrogen absorbing material is used. However, embodiments of the present invention do not always require the use of a hydrogen absorbing material, and similarly there are cases where the hydrogen storage device is configured without using a hydrogen absorbing agent.

### EXPLANATION OF THE REFERENCE NUMERALS

10 hydrogen storage device

11 stainless steel container

12 hydrogen flow inlet

13, 19 hydrogen flow outlet

14 activated carbon

20 porous magnetic body having iron oxide as a principal component

1. A hydrogen storage device, comprising:
a tank provided with a hydrogen flow opening, and a hydrogen absorbing material in at least one portion of the tank; and
a porous magnetic body disposed at the hydrogen flow opening.

2. The hydrogen storage device according to claim 1, wherein the tank includes a thermal insulating container.

3. The hydrogen storage device according to claim 1, wherein the hydrogen flow opening comprises a hydrogen flow inlet and a hydrogen flow outlet, and the porous magnetic body is disposed at the hydrogen flow outlet.

4. The hydrogen storage device according to claim 1, wherein the porous magnetic body is disposed so as to be able to exchange heat with a structural member of the tank.

5. The hydrogen storage device according to claim 4, wherein the structural member of the tank is a metal material.

6. The hydrogen storage device according to claim 1, wherein:
the tank comprises a thermal insulating structure comprising a shield material that includes a metal layer, the shield material being disposed between a thermal insulating material; and
the porous magnetic body is disposed so as to be able to exchange heat with the shield material.

7. The hydrogen storage device according to claim 1, wherein the porous magnetic body is disposed so as to be able to exchange heat with the internal atmosphere of the tank.

8. The hydrogen storage device according to claim 1, wherein the hydrogen absorbing material is activated carbon, carbon nanotubes or MOF.

9. The hydrogen storage device according to claim 1, wherein the porous magnetic body is iron oxide, a mixture of silica gel and nickel, or alumina on a chromium oxide carrier.

10. The hydrogen storage device according to claim 3, further comprising a hydrogen flow tube that hydrogen flows through and that is connected to the hydrogen flow outlet, wherein the porous magnetic body is held at at least one portion of the internal wall of the hydrogen flow tube.

11. The hydrogen storage device according to claim 3, further comprising a hydrogen flow tube that hydrogen flows through and that is connected to the hydrogen flow outlet, wherein the porous magnetic body fills at least one portion of the hydrogen flow tube.

12. The hydrogen storage device according to claim 10 or claim 11, wherein the hydrogen flow tube is disposed along a face of the external wall of the tank.

13. The hydrogen storage device according to claim 1, wherein the hydrogen absorbing material is provided within the tank at a face of an upper wall disposed in the opposite direction to the direction in which gravity acts.

14. The hydrogen storage device according to claim 6, wherein the shield material is a polyester film which has been subjected to aluminum vapor deposition on only one side.

15. The hydrogen storage device according to claim 6, wherein the thermal insulating structure comprises a layered structure including thermal insulating material, aluminum plate and thermal insulating material.

16. A hydrogen storage device comprising a porous magnetic body disposed at a hydrogen flow opening of a tank.

17. The hydrogen storage device according to claim 1, wherein liquid hydrogen is stored in the tank.

18. The hydrogen storage device according to claim 16, wherein:
the tank comprises a thermal insulating structure comprising a shield material that includes a metal layer, the shield material being disposed between a thermal insulating material; and
the porous magnetic body is disposed so as to be able to exchange heat with the shield material.

19. The hydrogen storage device according to claim 16, wherein the porous magnetic body is iron oxide, a mixture of silica gel and nickel, or alumina on a chromium oxide carrier.

20. The hydrogen storage device according to claim 16, wherein the hydrogen flow opening comprises a hydrogen flow inlet and a hydrogen flow outlet, the hydrogen storage device further comprising a hydrogen flow tube where hydrogen flows through and that is connected to the hydrogen flow outlet, wherein the porous magnetic body is held at or fills in at least one portion of the hydrogen flow tube, and the hydrogen flow tube is disposed along a face of the external wall of the tank.

21. The hydrogen storage device according to claim 16, wherein liquid hydrogen is stored in the tank.
